(19) United States
(12) Patent Application Publication
(10) Pub. No.: US 2004/0009263 A1
(43) Pub. Date: Jan. 15, 2004

(54) Methods for extracting corn proteins from corn gluten meal

(76) Inventors: Jingping Liu, Highland Park, NJ (US); Willy Weisheng Lee, Bridgewater, NJ (US)

Correspondence Address: BELL, BOYD & LLOYD LLC, P. O. BOX 1135, CHICAGO, IL, 60690-1135, US

(21) Appl. No.: 10/239,367

(22) PCT Filed: Feb. 2, 2001
(86) PCT No.: PCT/US01/03418

(51) Int. Cl. A23L 1/31

(52) U.S. Cl. 426/55

(57) ABSTRACT

Methods of extracting corn proteins from corn gluten meal are provided. Specifically, the methods employ water-soluble organic compounds containing sulfhydryl groups to improve corn protein yield. Additionally, chewing gums and methods of producing chewing gums which incorporate the corn proteins of the present invention are provided as well.

### BACKGROUND OF THE INVENTION

The present invention relates to commercial extraction processes. More specifically, the present invention relates to commercial corn protein extraction processes.

Corn as a plant-based food substrate generally contains approximately an 8-11% concentration of corn proteins. Examples of corn proteins include zeins, glutelins, albumins and globulins. Of these corn protein examples, zein comprises the major corn protein portion within corn, typically 60-70% of all corn proteins.

As the major corn protein portion, zein is rich in hydrophobic amino acid residues such as glutamine, leucine and alanine due to the unique hydrophobic, film-forming and firm texture properties of zein, the corn protein has been used within many food products to impart such properties. For example, zein has been utilized as a new mastication material in confectionery products.

Additionally, the medical community has reported that zein tripeptides may decrease blood pressure in human and animal subjects. In particular, medical literature indicates that such tripeptides may inhibit angiotensin-converting enzymes, which are known to elevate blood pressure in humans and animals. Thus, zein can be used as a functional food ingredient to impart circulatory properties.

Furthermore, zein exhibits unique semiconducting properties. As a result, zein has been indicated within the prior art as a possible edible microwave susceptor which could enhance food reconstitution efficiencies. However, to garner the various properties of zein, the corn protein must be efficiently and cost effectively extracted from corn sources.

A variety of zein extraction processes are generally known within the food protein extraction industry. Conventional zein extraction processes include the use of solvents to extract the corn protein. Examples of such solvents include a 75-95% concentrated aqueous alcohol solution heated to a temperature of 40-60° C.; a 0.2-5% alkaline solution; or a mixture of short chain alcohols intermixed with glycols or glycol ethers.

Among such conventional extraction solvents, the most common is a 70-90% concentration of ethanol or a 55-88% concentration of isopropyl alcohol. Frequently, conventional corn protein extraction processes result in low zein yields of only 22 percent when approximately 65 percent protein is available.

Therefore, conventional extraction processes alone cannot recover significant quantities of zein. Increasing the mass ratio of solvent to CGM solid will increase the yield slightly. However, the costs for extraction would increase as well.

To improve zein extraction yield from corn gluten meal, extraction aids such as small amounts of sodium acetate, phosphates, reducing agents or combinations thereof have been added to extraction solvents. In doing so, zein extraction yields of conventional zein extraction processes have increased, but not greatly.

Moreover, the addition of extraction aids has not been without some disadvantages. For example, 2-mercaptoethanol, a typical reducing agent extraction aid, is indicated within the Registry of Toxic Effects of Chemical Substances as being a highly toxic chemical to humans and animals. Thus, 2-mercaptoethanol cannot be used to manufacture food grade zein.

Because of the negative effects associated with conventional extraction aids, those familiar in this art have tried to improve zein yield from a corn gluten meal source by optimizing zein extraction processing using orthogonal tests. Such tests were used to optimize the raw material, pre-treatment, solvent extraction and separation by precipitation steps of conventional zein extraction processing.

For example, such orthogonal tests indicate that zein extraction processing can be optimized using a 70% concentrated alcohol solvent; a raw material to solvent ratio of 1:16; a pH of 8.0; an extraction temperature of 70° C.; and a 2% NaCl concentration after pH adjustment. By optimizing zein extraction conditions, it has been shown in the prior art that zein yield was improved to 87.9% and zein purity within the final product to 91.2%. However, as indicated by the ratio of raw material to solvent, this procedure needs a much higher amount of solvent. Thus, the cost of manufacturing zein remains high.

Therefore, improved methods of extracting corn proteins are desirable.

### SUMMARY OF THE INVENTION

The present invention provides improved methods for extracting food grade proteins from plant sources. More specifically, the present invention provides improved methods for extracting food grade corn proteins from corn gluten meal.

To this end, the present invention provides a method of providing corn protein from corn gluten meal comprising the step of pre-treating corn gluten meal with a pre-treatment solution comprising a water-soluble organic compound containing sulfhydryl groups or proteases.

In an embodiment of the method, the water-soluble organic compound containing sulfhydryl groups is a member selected from the group consisting of amino acids, enzymes, derivatives thereof and combinations thereof.

In an embodiment, the sulfhydryl group containing amino acid is a member selected from the group consisting of cysteine, cysteine hydrochloride, homocysteine, mecysteine hydrochloride, glutathione, acetylcysteine, derivatives thereof and combinations thereof.

In an embodiment of the method, the protease enzyme is a member selected from the group consisting of serine proteases, thio or cysteine proteases, carboxyl or aspartic proteases, metalloproteases, derivatives thereof and combinations thereof.

In an embodiment of the method, the food grade microbial protease enzyme is a member selected from the group consisting of fungal proteases, bacterial proteases, derivatives thereof and combinations thereof.

The present invention also provides a method of extracting corn proteins from corn gluten meal comprising the steps of pre-treating an effective amount of corn gluten meal with an effective amount of a pre-treatment solution comprising a water-soluble organic compound containing sulfhydryl groups; extracting corn proteins from the pre-treated corn gluten meal with an effective amount of a solvent; and separating the corn proteins from the solvent.

In an embodiment of the method, the pre-treatment reagents are the members selected from the group consisting of amino acids, proteases and combinations thereof.

In an embodiment of the method, the corn gluten meal is pre-treated with the pre-treatment solution for a sufficient period of time ranging approximately up to 24 hours.

In an embodiment of the method, the corn gluten meal is pre-treated with the pre-treatment solution at a sufficient temperature ranging from approximately 20° C. to about 60° C.

In an embodiment of the method, the effective amount of the corn gluten meal is a ratio of the corn gluten meal to the pre-treatment solution of a approximately 1:2.

In an embodiment of the method, the effective amount of pre-treatment solution is a concentration of the sulfhydryl group containing amino acid, proteases, derivatives thereof, or combinations thereof within the pre-treatment solution ranging from approximately 0.01% to about 5%.

In an embodiment of the method, the pre-treatment solution has a pH of less than or equal to 7.

Additionally, the present invention also provides a method of extracting corn proteins from corn gluten meal comprising the steps of grinding the corn gluten meal; pre-treating the ground corn gluten meal with a pre-treatment solution comprising a water-soluble organic compound containing sulfhydryl groups; extracting the corn proteins from the pre-treated ground corn gluten meal with a solvent; and separating the corn proteins from the solvent.

In an embodiment of the method, the corn gluten meal is ground to a particle size of approximately about 10 μm to about 200 μm.

Still further, the present invention also provides a chewing gum composition comprising a water insoluble gum base portion; a water-soluble portion; a sweetener; a flavor; and a coating comprising a corn protein extracted from corn gluten meal having been pre-treated with a pre-treatment solution comprising a water-soluble organic compound containing sulfhydryl groups.

In addition, the present invention provides a chewing gum base comprising a water insoluble gum base portion and water soluble portion, and a corn protein extracted from corn gluten meal having been pre-treated with a pre-treatment solution comprising a water-soluble organic compound containing sulfhydryl groups.

In another embodiment, the present invention provides a method of producing a chewing gum composition comprising the steps of pre-treating corn gluten meal with a pre-treatment solution comprising a water-soluble organic compound containing sulfhydryl groups; extracting corn proteins from the pre-treated corn gluten meal with a solvent; separating the corn proteins from the solvent; and incorporating the corn proteins with a chewing gum carrier comprising a water-insoluble gum base portion; a water-soluble portion; a sweetener, and a flavor.

In an embodiment of the method, the method further comprises the step of grinding the corn gluten meal to a sufficient particle size prior to pre-treatment with the pre-treatment solution.

An advantage of the present invention is to provide-improved extraction methods of increasing corn protein yield.

Another advantage of the present invention is to provide improved methods of extracting corn proteins from corn gluten meal cost effectively.

A further advantage of the present invention is to provide improved methods of extracting food grade corn proteins from corn gluten meal using non-toxic materials.

A still further advantage of the present invention is to provide improved chewing gum compositions and methods of making the same.

Additional features and advantages of the present invention will be described in and apparent from the detailed description of the presently preferred embodiments and figure.

### BRIEF DESCRIPTION OF THE FIGURE

FIG. 1 illustrates graphically cleavage of disulide bonds of the zein body membranes.

### DETAILED DESCRIPTION OF THE PRESENTLY PREFERRED EMBODIMENTS

Pursuant to the present invention, improved methods of extracting corn proteins, namely zein, from a corn gluten meal source to increase corn protein yield are provided. Corn proteins produced by the extraction methods of the present invention are also provided. Additionally, chewing gums and methods of making chewing gums which incorporate the extracted corn proteins of the present invention are provided as well.

To this end, in an embodiment of the present invention a method of increasing corn protein yield, preferably zein, from corn gluten meal is provided. The method comprises the step of pre-treating corn gluten meal with a pre-treatment solution comprising a water-soluble organic compound containing sulfhydryl groups.

Zein is a corn protein located within spherical organelles often referred to as zein protein bodies which reside within the endoplasmic reticulum of corn cells. Such zein protein bodies generally exhibit a low water holding capacity and a firm texture. This is due in part because zein is composed of more than 50% nonpolar amino acid residues such as leucine, isoleucine, valine, alanine, proline and glutamine.

Due to zein's abundance of nonpolar residues, the corn protein is primarily soluble in alcohol and insoluble in water. Thus, during corn-wet milling processes, zein protein bodies are difficult to rupture.

As a corn protein, zein, can be classified into three major classes. Alpha-zein constitutes approximately 75%-85% of the total zein content within a zein protein body; typically resides within the central portion of the zein protein body; and is readily soluble in a 50%-95% concentration of aqueous alcohol.

Beta-zein and gamma-zein generally constitute 10%-15% or 5%-10% of the total zein content within a zein protein body, respectively. Both beta- and gamma-zein are located in the outside layer of a zein protein body. These two types of zein contain less amounts of hydrophobic amino acid residues than alpha-zein, but five to seven times greater the amount of disulfide bonds.

Because of such high concentrations of disulfide bonds, beta- and gamma-zein only dissolve in aqueous alcohols in the presence of one or more reducing agents. Although not wanting to be bound to any particular theory, it is believed that beta- and gamma-zeins located in the outside layer of zein protein bodies prevent rupture of that body during conventional corn-wet milling processes because of their high disulfide bond content. For example, it has been found that even small amounts of gamma-zein will greatly increase the stability and retention of alpha-zein within the endoplasmic reticulum of zein protein bodies.

Therefore, it is further believed that the disruption of the intermolecular disulfide bonds within beta- and gamma-zeins located in the outside layer of zein protein bodies will increase the yield of zein from those bodies. By rupturing those disulfide bonds, the outside layer of a zein protein body can be weakened to release greater concentrations of alpha-zein. In doing so, greater percentages of zein proteins, namely alpha-zein, can be recovered during corn protein extraction to increase corn protein yield.

To illustrate, set forth below is the chemical interchange reaction Formula in which disulfide (—S—S—) bonds within a protein backbone i.e., the beta- or gamma-zein protein outer layer of a zein protein body, are broken utilizing an organic water-soluble compound containing at least one sulfhydryl group (—SH).

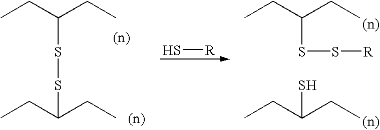

R=carbon group including but not limited to:

—CH₂CH(NH₂)COOH;

—CH₂CH₂CH(NH₂)COOH;

—CH₂CH(NH₂*HCL)COOH;

—CH₂CH(NHCOCH₃)COOH;

—CH₂C(CONHCH₂COOH)NHCO(CH₂)₂CH(NH₂)COOH

Usually, a protein backbone is not very reactive chemically. A peptide bond is hydrolyzed very slowly at neutral pH and room temperature. However, as the Formula indicates, the protein backbone of beta- and gamma-zeins within zein protein bodies can be broken down utilizing water-soluble organic compounds containing sulfhydryl groups to catalyze disulfide-sulfhydryl transition reactions. By introducing sulfhydryl groups, the crosslinking network of disulfide bonds within beta- and gamma-zeins located in the outside layer of zein protein bodies can be disrupted to release greater concentrations of alpha-zein for recovery

In this regard, the present invention increases corn protein yield, namely that of zein, by pre-treating corn protein sources such as corn gluten meal with a water-soluble organic compound containing sulfhydryl groups to introduce those groups into corn protein bodies to cause disulfide-sulfhydryl transition. Moreover, to overcome the toxicity associated with other conventional pre-treatment/extraction aids, the water-soluble organic compounds of the present invention are preferably non-toxic to increase the yield of food grade corn proteins.

Water-soluble organic compounds containing suflhydryl groups which can be used to achieve the objectives of the present invention include, but are not limited to, amino acids, and combinations thereof.

Examples of sulfhydryl group containing amino acids include, but are not limited to, cysteine; cysteine hydrochloride; homocysteine; mecysteine hydrochloride; glutathione; acetylcysteine; derivatives thereof and combinations thereof Preferably, the sulfhydryl group containing amino acid is cysteine, more preferably cysteine hydrochloride and most preferably cysteine-monohydrochloride.

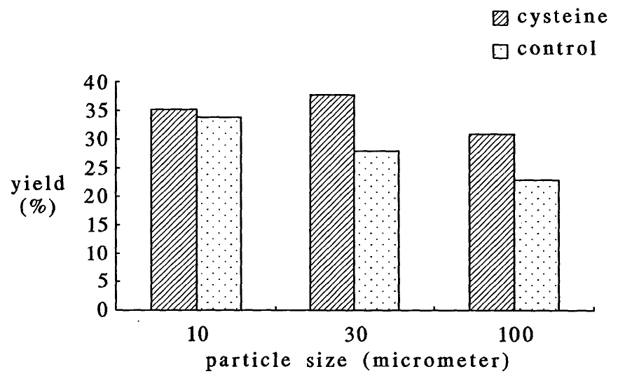

As can be seen in FIG. 1 and the results tabulated within Table 1 below, the introduction of cysteine into corn gluten meal significantly improves zein yield. Cysteine is an edible amino acid that is rich in sulfhydryl groups. Therefore, the addition of cysteine to corn gluten meal results in the disulfide-sulfhydryl transition reaction necessary to weaken the beta- and gamma-zein outside layer of zein protein bodies to release alpha-zein.

TABLE 1

| CGM | Plasticizing | | Yield |
|---|---|---|---|
| particle size | aid | Extraction condition | (%) |
| 30 m | no | 88% Isopropanol /2 days | 6 |
| 30 m | no | 74% Isopropanol /2 days | 14 |
| 30 m | cysteine | 74% Isopropanol /0.1% acid /2 days | 23 |
| 30 m | no | 10 g H₂O or 0.5% acid solution | 28 |
| 30 m | cysteine | overnight | 38 |
| 30 m | cysteine-HCI | 27 g Isopropanol /2 days | 39 |
| 30 m | cysteine | (equivalent to 73% Isopropanol) | 33 |
| 10 m | no | | 34 |
| 10 m | cysteine | | 35 |
| 100 m | no | | 23 |

Furthermore, as Table 1 indicates, cysteine-hydrochloride in a low pH pre-treatment solution environment had the best disulfide-sulfhydryl transition result. It is believed that in neutral or slightly alkaline aqueous solutions, the sulfhydryl groups of cysteine can be oxidized to disulfide. However, in acidic aqueous solutions, the sulfhydryl groups of cysteine can exist for extended periods of time.

Thus, in a preferred embodiment of the method, the sulfhydryl containing amino acids within the pre-treatment solution of the present invention are buffered to a pH ranging approximately from about 4 to about 7, more preferably from about 4 to about 6.

Additionally, the crosslinking network of beta- and gamma-zein within zein protein bodies can also be broken by protease enzymes and via enzymatic hydrolysis using those enzymes. Examples of protease enzymes include, but are not limited to, serine proteases; thio or cysteine proteases; carboxyl or aspartic proteases; metalloproteases; derivatives thereof; and combinations thereof.

Serine proteases are generally divided into two families which include the bacterial protease subtilisin family and the trypsin family. Examples of the subitilisin family include, but are not limited to, Alkaline Protease Concentrate (a bacterial protease liquid concentrate obtained from a non-genetically modified strain of Bacillus licheniformis (660 DAPU/g) obtained from Valley Research, Inc.); Alcalase (obtained from Novo Nordisk BioChem North America, Inc.); Validase TSP200 (obtained from Valley Research, Inc.); and Protamex (obtained from Novo Nordisk BioChem North America, Inc.). Examples of the trypsin family include, but are not limited to, chymotrypsin; trypsin; elastase; thrombin; plasmin; kallikrein; and acrosin.

The difference in the families occurs due to each family catalyzing the protein backbone cleavage within zein protein bodies at different amino acid side chains. Each of the various serine proteases has a different preference for those amino acid side chains at the cleaved peptide bond and residuals at the neighboring position.

For example, chymotrypsin prefers to cleave peptide bonds after large hydrophobic residuals. Alkaline Protease Concentrate of the subtilisin family, however, has a less distinct preference at the residual on the cleaved peptide bond. Yet, as Table 2 below indicates, Alkaline Protease Concentrate is effective in increasing corn protein yield, namely zein, from corn gluten meal.

TABLE 2
(Zein Corn Protein Yield Improvement
Using Alkaline Protease Concentrate)

| | 1 | 2 | 3 | 4 |
|---|---|---|---|---|
| CGM particle size | >100 m | 30 m | 10 m | 30 m |
| Solvent/CGM | 7.4 | 7.4 | 7.4 | 7.4 |
| E/S* | 1% | 1% | 1% | 0 |
| Yield (%) | 14.8 | 26.8 | 32.6 | 17.4 |

In thio or cysteine proteases, the cysteine side chain within a protein backbone is the active site. Examples of thio or cysteine proteases include, but are not limited to, papain; ficin; bromelain; and actinidin.

For carboxyl proteases, the carboxyl group, usually aspartyl, is the active site. Examples of carboxyl proteases include, but are not limited to, pepsin; gastricsin; and chymosin.

With respect to metalloproteases, such proteases employ bonded metal ions like Zn⁺⁺ and Ca⁺⁺ in their active sites. Examples of metalloproteases include, but are not limited to, Carboxypeptidases A and B; thermolysin; angiotensin-converting enzyme; enkephalinase; and collagenase (Zn⁺⁺).

In addition, depending upon the functional groups of the active sites for the protease enzymes of the present invention, such enzymes can be further subdivided into additional classifications depending upon the various types of proteases each can produce.

Preferably, the food grade microbial or plant extract protease enzymes contain serine proteases, thio or cysteine proteases, carboxyl or aspartic proteases, metalloproteases, derivatives thereof and combinations thereof. More preferably, the food grade microbial protease enzyme or plant protease extract contains a serine or thio proteases.

The present invention also provides a method of extracting corn proteins from corn gluten meal comprising the steps of pre-treating an effective amount of corn gluten meal with an effective amount of a pre-treatment solution comprising a water-soluble organic compound containing sulfhydryl groups or proteases; extracting corn proteins from the pre-treated corn gluten meal with an effective amount of a solvent; and separating the corn proteins from the solvent. Preferably, the method of extraction of the present invention is used to extract zein corn proteins from corn gluten meal.

In an embodiment of the method, the water-soluble organic compound acting as the pre-treatment solution is a member selected from the group consisting of amino acids; protease enzymes; derivatives thereof; and combinations thereof.

The sufficient period of time to pre-treat the corn gluten meal with the pre-treatment solution preferably ranges approximately up to 24 hours, more preferably about 2 hours to about 5 hours, to ensure proper break down of the outside layer of the zein protein bodies to enhance release of increased quantities of alpha-zein. In addition, the effective amount of the pre-treatment solution is preferably a concentration of the amino acid, protease enzyme, proteinase enzyme, food grade microbial protease enzyme, food grade plant extract protease enzyme, derivatives thereof, or combinations thereof within the pre-treatment solution ranging from approximately 0.01% to about 5%, more preferably 0.05% to about 2%, most preferably 0.1% to about 1%.

Moreover, the effective amount of the corn gluten meal utilized within the extraction method of the present invention is preferably a ratio of corn gluten meal to pre-treatment solution of approximately 1:2.

Heat can also accelerate the solvent extraction procedure of the present invention and improve solubility of the zein protein bodies within the pre-treatment solution. The temperature of the extraction method of the present invention preferably ranges from approximately 20° C. to about 60° C., more preferably 25° C. to about 35° C. Although heat can accelerate the solvent extraction procedure of the present invention and improve solubility, may damage corn protein yield.

Maintaining a proper pH for the pre-treatment solution can also be utilized to enhance the efficiency and effectiveness of the extraction method of the present invention. Preferably, the pH of the pre-treatment solution ranges approximately up to 7, more preferably between about 4 to about 6.

Solvents for the present invention include any food grade solvent that can be used to extract corn proteins. Examples of suitable solvents of the present invention include, but are not limited to, a 75-95% concentration of an aqueous alcohol solution heated to a temperature of approximately 40-60° C.; a 0.2-5% concentration of an alkaline solution; a mixture of short chain alcohols intermixed with glycols or glycol ethers; derivatives thereof; and combinations thereof.

Preferably, the solvent of the present invention is ethanol or isopropyl alcohol, more preferably a 70-90% concentration of ethanol or a 55-88% concentration of isopropyl alcohol.

In addition to the chemical disruption of zein protein bodies by the sulfhydryl group containing organic compounds of the present invention, the outside layer of such bodies can also be weakened or broken down by intense mechanical force. For example, it has been reported that the amount of mechanical energy per unit mass of material processed, which is defined as specific mechanical energy (SME), is proportional to the severity of disruption of protein bodies (Batterman-Azcona, 1998).

In an alternative embodiment, the present invention provides a method of extracting corn proteins from corn gluten meal comprising the steps of grinding corn gluten meal to a sufficient particle size; pre-treating the ground corn gluten meal with a pre-treatment solution comprising a water-soluble organic compound containing sulfhydryl groups; extracting corn proteins from the pre-treated corn gluten meal with a solvent; and separating the corn proteins from the solvent.

In a preferred embodiment of the alternative method, the sufficient particle size of the ground corn gluten meal ranges approximately from about 10 μm to about 200 μm, more preferably from about 25 μm to about 30 μm. As can be seen in Tables 1 and 2, when corn gluten meal is ground mechanically into fine particle sizes, corn protein yield, namely that of zein, is significantly improved.

Moreover, by way of example and not limitation, the following extraction methods set forth within Examples 1-3 below illustrate various embodiments of the present invention. It should be appreciated by those skilled in the art that the methods of the present invention can be conducted in a variety of different manners, which are appropriate to achieve the objectives of the present invention. Of course, many other variations of the methods are possible, but can be appreciated by a skilled technician once the fundamental concepts and principles of the present invention are grasped.

By way of Example, and not limitation, Examples of the present invention will now be given.

### EXAMPLES 1-3

### Example 1

(Corn Gluten Meal/Cysteine Solution/Isopropanol Extraction Method):

Five (5) grams of corn gluten meal (obtained from ADM Corn-Processing of Decatur, Ill.) was added to a 50-ml centrifuge tube containing 10-ml of a 0.5% concentration of a cysteine pre-treatment solution (obtained from Ajinomoto of Teaneck, N.J.). The mixture was allowed to stand for a half hour period of time. Following that period of time, 27-ml of 2-propanol (obtained from Spectrum of New Brunswick, N.J.) was added to the tube and left to stand at ambient temperature for approximately an eight hour period of time.

The mixture was then centrifuged for 15 minutes in a Beckman Model TJ-6 Centrifuge. Following centrifugation, the supernatant was decanted and filtered. The filtered solution was then heated on a hot plate having a temperature of approximately 140° F. for 1 hour.

After heating, the material was then put into a vacuum over for 8 hours at 50° C./30 inHg to recover zein. The zein yield was calculated as the percentage of the dry solid weight in comparison to the total corn gluten meal weight.

### Example 2

(Corn Gluten Meal/Protease/Isopropanol Extraction Method):

Five (5) grams of corn gluten meal (obtained from ADM Corn-Processing of Decatur, Ill.) was added to a 50-ml centrifuge tube containing 10-ml of a 0.5% Alkaline Protease Concentrate solution (obtained from Valley Research of South Bend, Ind.) and left to stand for a half hour period of time. Then, 27-ml of 2-propanol (obtained from Spectrum of New Brunswick, N.J.) was added to the mixture and left to stand at ambient temperature for a period of approximately 8 hours.

The mixture was centrifuged for 15 minutes in a Beckman Model TJ-6 Centrifuge. The supernatant was decanted and filtered. The filtered solution was then heated on a hot plate having a temperature of approximately 140° F. for 1 hour and then put into a vacuum oven for 8 hours at 50° C./30 inHg. Following the vacuum oven step, zein was recovered and zein yield was calculated as the percentage of dry solid weight from the total corn gluten meal weight.

### Example 3

(Ground Corn Gluten Meal/Cysteine/Isopropanol Extraction Method):

Corn gluten meal (obtained from ADM Corn Processing of Decatur, Ill.) was ground into a fine powder having a particle sizes of approximately 30 μm. Five (5) grams of the ground corn gluten meal was then added to a 50-ml centrifuge tube containing approximately 10-ml of a 0.5% cysteine solution (obtained from Ajinomoto of Teaneck, N.J.) and left to stand for approximately a half of an hour.

Then, 27-ml of 2-propanol (obtained from Spectrum of New Brunswick, N.J.) was added into the tube and the mixture was left to stand at ambient temperature for approximately 8 hours. The mixture was then centrifuged for 15 minutes using a Beckman Model TJ-6 Centrifuge. The supernatant was decanted and filtered.

The filtered solution was subsequently heated on a hot plate having a temperature of approximately 140° F. for 1 hour and then put into a vacuum oven for 8 hours at 50° C./30 inHg. The dried corn proteins, namely zein, were recovered. Zein yield was calculated as the percentage of total corn gluten meal weight.

The zein yields are summarized in Examples 1-3. As FIG. 1 indicates, the corn protein extraction methods of the present invention can improve total zein (alpha-, beta- and gamma-) yield from corn gluten meal by approximately 10% or greater than currently available extraction methods.

By pre-treating corn protein sources with the sulfhydryl group containing organic compounds of the present invention, additional extraction processing is significantly reduced or eliminated while still achieving increased corn protein yields. Therefore, the present invention reduces extraction costs by decreasing extraction processing time and the amount of extraction solvent necessary to gamer an improved corn protein yield.

The present invention also provides a chewing gum composition comprising a water insoluble gum base portion; a water-soluble portion; a sweetener; a flavor; and a coating comprising a corn protein extracted from corn gluten meal having been pre-treated with a pre-treatment solution comprising a water-soluble organic compound containing sulfhydryl groups.

By providing the corn proteins of the present invention as a coating for chewing gum, such corn proteins enhance the structure and texture of the gum while varying its firmness when chewed. For example, it is believed that zein improves the texture of the gum by increasing its softness during chewing.

In general, a chewing gum typically comprises a water-soluble portion, a water-insoluble gum base portion; a sweetener; and a flavoring agent. The water-soluble portion dissipates during chewing. The water-insoluble gum base portion, however, is retained in the mouth throughout the chew. The term chewing gum refers to both a chewing and bubble gum in its general use.

The water-insoluble gum base generally comprises elastomers, resins, fats and oils, softeners and inorganic fillers. The gum base may or may not include wax. The gum base can constitute approximately 5% to about 95% by weight of the chewing gum, more commonly the base comprises approximately 10% to about 50% by weight of the gum, and in some preferred embodiments approximately 15% to about 35%, by weight of the gum.

In an embodiment, the water-insoluble gum base of the present invention contains approximately 20% to about 60% by weight synthetic elastomer; approximately upto about 30% by weight natural elastomer; approximately 5% to about 55% by weight elastomer plasticizer; approximately 4% to about 35% by weight filler; approximately 5% to about 35% by weight softener; and optional minor amount (about 1% or less by weight) of miscellaneous ingredients such as colorants, antioxidants, et cetera.

Elastomers provide the rubbery, cohesive nature of the gum which varies depending upon this ingredient's chemical structure and how it is intermixed with other ingredients of the chewing gum. Synthetic elastomers may include, but are not limited to, polyisobutylene; isobutylene-isoprene copolymer (butyl rubber); styrene-butadiene copolymers having styrene-butadiene ratios of about 1:3 to about 3:1; polyvinyl acetate; vinyl acetate-vinyl laurate copolymers having a vinyl laurate content of approximately 5% to about 50% by weight of the copolymer; derivatives thereof; and combinations thereof.

Natural elastomers may also be used within the water-insoluble chewing gum base of the present invention. Such elastomers include, but are not limited to, natural rubber such as smoked or liquid latex and guayule as well as natural gums such as jelutong; lechi caspi; perillo; sorva; massaranduba balata; massaranduba chocolate; nispero; roindinha; chicle; gutta hang kang; derivatives thereof and combinations thereof.

The preferred synthetic elastomer and natural elastomer concentrations vary depending upon whether the final chewing gum in which the gum base is used is adhesive or conventional, bubble gum or regular gum. Preferred synthetic elastomers include polyisobutylene, isobutylene-isoprene copolymers and styrene-butadiene copolymers. Preferred natural elastomers include jeluton, chicle, sorva and massaranduba balata.

Elastomer plasticizers may include, but are not limited to, rosin esters such as glycerol esters of rosin, methyl esters of rosin, pentaerythritol esters of rosin; terpene resins derived from alpha-pinene, beta-pinene, and/or d-limonene; derivatives thereof; and combinations thereof. The resin tackifiers regulate the cohesiveness and tackiness of the final gums. The preferred elastomer plasticizers will also vary depending on the specific application and on the type of elastomer which is used.

Fillers/texturizers may include magnesium and calcium carbonate; ground limestone; silicate types such as magnesium and aluminum silicate; clay; alumina; talc; titanium oxide; mono-, di-, and tri-calcium phosphate; cellulose polymers such as wood; derivatives thereof; and combinations thereof. Fillers modify the texture of the gum base. The fillers can also be organic powders which may include, but are not limited to, polyethylene; oat fiber; wood fiber; apple fiber; gliadin; casein; derivatives thereof; and combinations thereof. Preferably, the filler/texturizer is a corn protein of the present invention such as zein.

Softeners/emulsifiers may include, but are not limited to, tallow; hydrogenated tallow; hydrogenated and partially hydrogenated vegetable oils; cocoa butter; glycerol monostearate; glycerol triacetate; lecithin; non-hydrogenated, partially, or fully hydrogenated mono-, di-, and tri-glycerides from cottonseed, soybean, palm, palm kernel, coconut and safflower sources; other medium chain triglycerides; acetylated monoglycerides; fatty acids such as stearic, palmitic, oleic and linoleic acids; derivatives thereof; and combinations thereof. Such softeners/emulsifiers modify the texture of the gum base by introducing sharp melting transition during chewing.

Colorants and whiteners may also be added to the water-insoluble gum base. Such colorants and whiteners may include, but are not limited to, FD&C lakes and dyes; fruit and vegetable extracts; titanium dioxide; derivatives thereof; and combinations thereof. Colorants impart desirable visual characteristics to the gum base while removing or masking undesirable characteristics.

The gum base may or may not include wax as noted previously. An example of a wax-free gum base is disclosed in U.S. Pat. No. 5,286,500, the disclosure of which is incorporated herein by reference. Waxes aid in the curing of gum bases and in improving the shelf-life and texture of the final chewing gum product. Wax crystal also improves the release of flavor from the final gum product as well.

Gum bases are typically prepared by adding an amount of the elastomer, resin tackifier or softener, and filler to a pre-heated sigma blade mixer having a temperature of from approximately 50° F. to about 240° F. The initial amounts of ingredients comprising the initial mass of the insoluble gum base may be determined by the working capacity of the mixing kettle in order to attain a proper consistency. Such initial amounts may also be limited depending upon the degree of compounding needed to break down and soften the elastomer. The longer the compounding period and use of lower molecular weight and softening point gum base ingredients, a less firm and lower viscosity final chewing gum base will result.

In addition to the water-insoluble gum base, a typical chewing gum composition also includes a water-soluble portion; a sweetener; and one or more flavoring agents. The water-soluble portion can include bulk sweeteners, high intensity sweeteners, flavoring agents, softeners, emulsifiers, colorants, acidulants, fillers, antioxidants, medicaments, and other components that provide desired attributes to the final chewing gum.

Softeners are added to the water-soluble portion to optimize the chewability and mouth feel of the final gum product. Softeners, also known as plasticizers or plasticizing agents, generally constitute approximately 0.5% to about 25% by weight of the chewing gum. Such softeners include, but are not limited to, glycerin; lecithin; derivatives thereof; and combinations thereof. Aqueous sweetener solutions such as those containing sorbitol, hydrogenated starch hydrolysates, corn syrup, derivatives thereof and combinations thereof may also be used as softeners within the chewing gum of the present invention.

Bulk sweeteners include both sugar and sugarless components. Bulk sweeteners typically constitute approximately 5% to about 95% by weight of the chewing gum; more typically about 20% to about 80% by weight of the chewing gum; and most typically about 30% to about 60% by weight of the chewing gum. Sugar sweeteners generally include, but are not limited to, sucrose; dextrose; maltose; dextrin; dried invert sugar; fructose; levulose; galactose; corn syrup solids; derivatives thereof; and combinations thereof. Sugarless sweeteners include, but are not limited to, sugar alcohols such as sorbitol; mannitol; xylitol; hydrogenated starch hydrolysates; maltitol; derivatives thereof; and combinations thereof.

High intensity artificial sweeteners may also be used within the water-soluble portion of the chewing gum of the present invention. Examples of suitable artificial sweeteners include, but are not limited to, sucralose; aspartame; acesulfame; altitame; saccharin; cyclamic acid; glycerrhizinate; dihydrochalcones; thaumatin; monellin; derivatives thereof; and combinations thereof. The amounts of artificial sweetener in chewing gum formulations typically ranges from approximately 0.02% to about 0.10% by weight of the chewing gum for altitame, thaumatin and dihydrochalcones, and from approximately about 0.1% to about 0.2% by weight of the chewing gum for aspartame, sucralose, acesulfame and saccharin.

In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coacervation and fiber extension may be used to achieve the desired release characteristics for such artificial sweeteners.

Combinations of sugar and/or sugarless sweeteners natural or artificial may be used in the chewing gums of the present invention. If a low calorie gum is desired, a low caloric bulking agent can also be used. Examples of low calorie bulking agents include, but are not limited to, polydextrose; raftilose; raftilin; fructooligosaccharides; palatinose oligosaccharides; guar gum hydrolysates; ingestible dextrins; derivatives thereof; and combinations thereof.

A variety of flavoring agents can also be used, if desired, within the water-insoluble portion of the chewing gum of the present invention. Flavoring agents impart desirable taste characteristics to chewing gums while removing or masking undesirable taste sensations. Flavorant amounts within the chewing gum of the present invention can range from approximately about 0.1% to about 15% by weight of the gum, more preferably from about 0.2% to about 5% by weight of the gum.

Examples of suitable flavorants include, but are not limited to, essential oils; synthetic flavors; oils derived from plants and fruits such as citrus oils, fruit essences, peppermint oil, spearmint oil, other mint oils, clove oil, oil of wintergreen, anise; derivatives thereof; and combinations thereof. Natural and artificial flavoring agents such as cocoa powder and heat-modified amino acids can be used as flavoring agents within the present invention, and may be combined in any sensorially acceptable fashion.

The corn proteins of the present invention can also be used as a mastication material and can be combined with other ingestible ingredients to make ingestible chewing gum bases having improved taste and texture separate from a final chewing gum product. Therefore, in another embodiment, the present invention provides a chewing gum base comprising a water-insoluble gum base portion including a corn protein extracted from corn gluten meal having been pre-treated with a pre-treatment solution comprising a water-soluble organic compound containing sulfhydryl groups.

Moreover, the present invention provides a method of producing a chewing gum composition comprising the steps of pre-treating an effective amount of corn gluten meal with an effective amount of a pre-treatment solution comprising a water-soluble organic compound containing sulfhydryl groups; extracting corn proteins from the pre-treated corn gluten meal with an effective amount of a solvent; separating the corn proteins from the solvent; and incorporating the corn proteins with a chewing gum carrier comprising a water insoluble gum base portion; a water soluble portion; a sweetener; and a flavor.

In an alternative embodiment of the method, the corn gluten meal may be ground to a sufficient particle size prior to pre-treatment with the pre-treatment solution and the incorporation step may involve coating of the chewing gum carrier with the corn proteins.

Additionally, the method of making chewing gum of the present invention may include conventional chewing gum manufacturing steps to produce the final resultant chewing gum. For example, chewing gum is typically manufactured by sequentially adding the various chewing gum ingredients to a commercially available mixer known in the art. After the initial ingredients have been thoroughly mixed, the gum mass is discharged from the mixer and shaped into the desired form such as by rolling onto sheets and cutting into sticks; extruded into chunks; cast into pellets; or cast into balls.

The entire mixing procedure typically takes from approximately 5 to about 15 minutes, but longer mixing times may be required depending upon ingredient selection. Those skilled in the art will be able to recognize that many variations of the above-described chewing gum manufacture procedure may be followed to achieve the principles and objectives of the present invention.

It should be understood that various changes and modifications to the presently preferred embodiments described herein will be apparent to those skilled spirit and scope of the present invention and without diminishing its intended advantages. It is, therefore, intended that such changes and modifications be in the art. Such changes and modifications can be made without departing from the covered by the appended claims.

We claim:

1. A method of extracting corn protein from corn gluten meal comprising the step of:
treating corn gluten meal with a solution comprising a water-soluble organic compound containing sulfhydryl groups.

2. The method of claim 1, wherein the water-soluble organic compound is a member selected from the group consisting of amino acids, protease enzymes, derivatives thereof and combinations thereof.

3. The method of claim 2, wherein the sulfhydryl group containing amino acid is a member selected from the group consisting of cysteine, cysteine hydrochloride, homocysteine, mecysteine hydrochloride, glutathione, acetylcysteine, derivatives thereof and combinations thereof.

4. The method of claim 2, wherein the protease enzyme is a member selected from the group consisting of serine proteases, thio or cysteine proteases, carboxyl or aspartic proteases, metalloproteases, derivatives thereof and combinations thereof.

5. The method of claim 2, wherein the food grade microbial protease enzyme is a member selected from the group consisting of fungal proteases, bacterial proteases, derivatives thereof and combinations thereof.

6. A method of extracting corn proteins from corn gluten meal comprising the steps of:
pre-treating an effective amount of corn gluten meal with an effective amount of a pre-treatment solution comprising a water-soluble organic compound containing sulfhydryl groups or proteases;
extracting corn proteins from the pre-treated corn gluten meal with an effective amount of a solvent; and
separating the corn proteins from the solvent.

7. The method of claim 6, wherein the water-soluble organic compound is a member selected from the group consisting of amino acids, protease enzymes, derivatives thereof and combinations thereof.

8. The method of claim 6, wherein the corn gluten meal is pre-treated with the pre-treatment solution for a sufficient period of time up to approximately 24 hours.

9. The method of claim 6, wherein the corn gluten meal is pre-treated with the pre-treatment solution at a sufficient temperature from approximately 20° C. to about 60° C.

10. The method of claim 6, wherein the effective amount of the corn gluten meal is a ratio of corn gluten meal to pre-treatment solution of approximately 1:2.

11. The method of claim 6, wherein the effective amount of pre-treatment solution is a concentration of the sulfhydryl group containing amino acid, protease enzyme, proteinase enzyme, food grade microbial protease enzyme, food grade plant extract protease enzyme, derivatives thereof, or combinations thereof within the pre-treatment solution ranging from approximately 0.01% to about 5%.

12. The method of claim 6, wherein the pre-treatment solution has a pH of less than or equal to 7.

13. A method of extracting corn proteins from corn gluten meal comprising the steps of:
grinding corn gluten meal;
pre-treating the ground corn gluten meal with a pre-treatment solution comprising a water-soluble organic compound containing sulfhydryl groups;
extracting corn proteins from the pre-treated corn gluten meal with a solvent; and
separating the corn proteins from the solvent.

14. The method of claim 13, wherein the corn gluten meal is ground to a particle size of about 10 μm to about 200 μm.

15. A chewing gum composition comprising:
a water insoluble gum base portion;
a water soluble portion;
a sweetener;
a flavor; and
a coating comprising a corn protein extracted from corn gluten meal having been pre-treated with a pre-treatment solution including a water-soluble organic compound containing sulfhydryl groups or proteases.

16. The chewing gum composition of claim 15, wherein the water-soluble organic compound is a member selected from the group consisting of amino acids, protease enzymes, derivatives thereof and combinations thereof.

17. A chewing gum base comprising:
a water insoluble gum base portion including a corn protein extracted from corn gluten meal having been pre-treated with a pre-treatment solution comprising a water-soluble organic compound containing sulfhydryl groups or proteases.

18. A method of producing a chewing gum composition comprising the steps of:
pre-treating an effective amount of corn gluten meal with an effective amount of a pre-treatment solution comprising a water-soluble organic compound containing sulfhydryl groups or proteases;
extracting corn proteins from the pre-treated corn gluten meal with an effective amount of a solvent;
separating the corn proteins from the solvent; and
incorporating the corn proteins with a chewing gum carrier that includes a water insoluble gum base portion, a water soluble portion, a sweeter, and a flavor.

19. The method of claim 18, wherein the method further comprises the step of grinding the corn gluten meal to a sufficient particle size prior to pre-treatment with the pre-treatment solution.

20. The method of claim 18, wherein the incorporation step involves coating the chewing gum with the corn proteins.
